(19) United States
(12) Patent Application Publication
(10) Pub. No.: US 2004/0239627 A1
(43) Pub. Date: Dec. 2, 2004

(54) Mouse cord stowing mechanism

(75) Inventors: Tiem Shun Ma, Tucheng City (TW); Jao Ching Lin, Taoyuan City (TW); Chien Cheng Huang, Taoyuan (TW)

Correspondence Address: BACON & THOMAS, PLLC, 625 SLATERS LANE, FOURTH FLOOR, ALEXANDRIA, VA, 22314

(73) Assignee: ASIA VITAL COMPONENTS CO., LTD., Kaohsiung (TW)

(21) Appl. No.: 10/445,902

(22) Filed: May 28, 2003

(51) Int. Cl. G09G 5/08

(52) U.S. Cl. 345/163

(57) ABSTRACT

A mouse cord stowing mechanism mainly includes a groove provided on a mouse for a mouse cord to wind therearound when the mouse is not in use, a locating member provided closely behind a connector connected to a free end of the mouse cord, an engaging portion provided on the locating member, and a receiving portion provided on the mouse corresponding to the engaging portion. With the locating member attached to the mouse through engagement of the engaging portion with the receiving portion, a loosened and space-occupying mouse cord and a damaged mouse cord connector may be avoided to extend the usable life of the mouse. The engaging and receiving portions may be differently designed and provided at different positions on the mouse.

### FIELD OF THE INVENTION

The present invention relates to a mouse cord stowing mechanism, and more particularly to a mouse cord stowing mechanism that includes a groove provided on a mouse having a mouse cord, a locating member provided closely behind a connector connected to a free end of the mouse cord, an engaging portion provided on the locating member, and a receiving portion provided on the mouse corresponding to the engaging portion. The mouse cord may be wound around and thereby stowed in the groove with the locating member attached to the mouse through engagement of the engaging portion with the receiving portion.

### BACKGROUND OF THE INVENTION

A mouse is one of many computer peripherals most frequently operated by a user. In the case of a desktop computer, the mouse is usually fixedly connected to a mainframe of the computer without the need of frequently disconnecting it therefrom. However, in the case of a notebook computer or in some other special cases where the mouse is to be frequently detached from the mainframe, the stowing of the long mouse cord forms a troublesome problem for the user. Most users would usually arbitrarily wind the mouse cord around an outer case of the mouse. In this case, the mouse cord is subject to an external pressure and tends to become damaged to reduce the sensitivity and usable life of the mouse. The mouse cord disorderly wound around the mouse also increases an overall volume of the mouse and tends to loosen from the mouse, causing inconveniences in carrying the mouse.

U.S. Pat. No. 6,392,635 discloses a mouse having a retractable mouse cord and a connector receiving space. A winder in the form of an eccentric spring reel is provided in the mouse to store, dispense, and rewind the mouse cord, so that the mouse cord in an extended position may retract and be received in an inner case of the mouse. A disadvantage of the mouse disclosed in U.S. Pat. No. 6,392,635 is it has complicate structure and requires more manufacturing procedures and costs to reduce the production efficiency thereof.

Taiwan Patent Publication No. 519264 discloses a mouse having a cord-collecting space. The mouse includes a main body, a cord, an upper case, a lower case, a central shaft extended between and connecting the upper case and the lower case to each other, and a cord-collecting space surrounding the central shaft. The mouse cord may be received in the main body of the mouse by winding it around the central shaft to locate in the cord-collecting space. While the mouse disclosed in Taiwan Patent Publication No. 519264 allows effective stowing of the mouse cord in the main body thereof, a connector connected to a free end of the mouse cord is not received in the cord-collecting space or fixed in place on the mouse. Therefore, the connector tends to be twisted or otherwise vibrated to result in damage or break at a joint of the connector and the cord, and is subject to damage due to external pressure applied thereto. All these factors would reduce the usable life of the mouse.

It is therefore tried by the inventor to develop a mouse cord stowing mechanism to overcome the disadvantages existed in the prior art.

### SUMMARY OF THE INVENTION

A primary object of the present invention is to provide a mouse cord stowing mechanism that effectively positions a mouse cord, including a connector connected to a free end thereof, on a mouse.

Another object of the present invention is to provide a mouse cord stowing mechanism that allows a connector connected to a free end of the mouse cord to be conveniently attached to the mouse at a selected position.

To achieve the above and other objects, the mouse cord stowing mechanism of the present invention mainly includes a groove provided on a mouse for a mouse cord to orderly wind therearound when the mouse is not in use, a locating member provided closely behind a connector connected to a free end of the mouse cord, an engaging portion provided on the locating member, and a receiving portion provided on the mouse corresponding to the engaging portion. With the locating member attached to the mouse through engagement of the engaging portion with the receiving portion, the connector at the free end of the mouse cord is located in place on the mouse without the risk of being arbitrarily vibrated or twisted. A damaged mouse cord and connector may therefore be avoided to extend the usable life of the mouse while the mouse may be stowed with occupying only a reduced space.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectioned side view showing a mouse cord stowing mechanism according to a first embodiment of the present invention;

FIG. 1A is an enlarged view of the circled area of FIG. 1;

FIG. 2 is a sectioned side view of the first embodiment of the present invention with a mouse cord stowed therein;

FIG. 2A is an enlarged view of the circled area of FIG. 2;

FIG. 3 is a bottom plan view of FIG. 2;

FIG. 4 is a sectioned side view showing a mouse cord stowing mechanism according to a second embodiment of the present invention;

FIG. 4A is an enlarged view of the circled area of FIG. 4;

FIG. 5 is a top plan view of FIG. 4;

FIG. 6 is a sectioned end view showing a mouse cord stowing mechanism according to a third embodiment of the present invention;

FIG. 6A is an enlarged view of the circled area of FIG. 6;

FIG. 7 is a side view showing the third embodiment of the present invention;

FIGS. 8 and 9 are exploded perspective and sectional views, respectively, showing an alternative form for the engaging and receiving portions of the present invention;

FIGS. 10 and 11 are exploded perspective and sectional views, respectively, showing another alternative form for the engaging and receiving portions of the present invention;

FIGS. 12 and 13 are exploded perspective and sectional views, respectively, showing a further alternative form for the engaging and receiving portions of the present invention; and

FIGS. 14 and 15 are exploded perspective and sectional views, respectively, showing a still further alternative form for the engaging and receiving portions of the present invention.

### DETAILED DESCRIPTION OF THE PREFERRED EMBODIMENTS

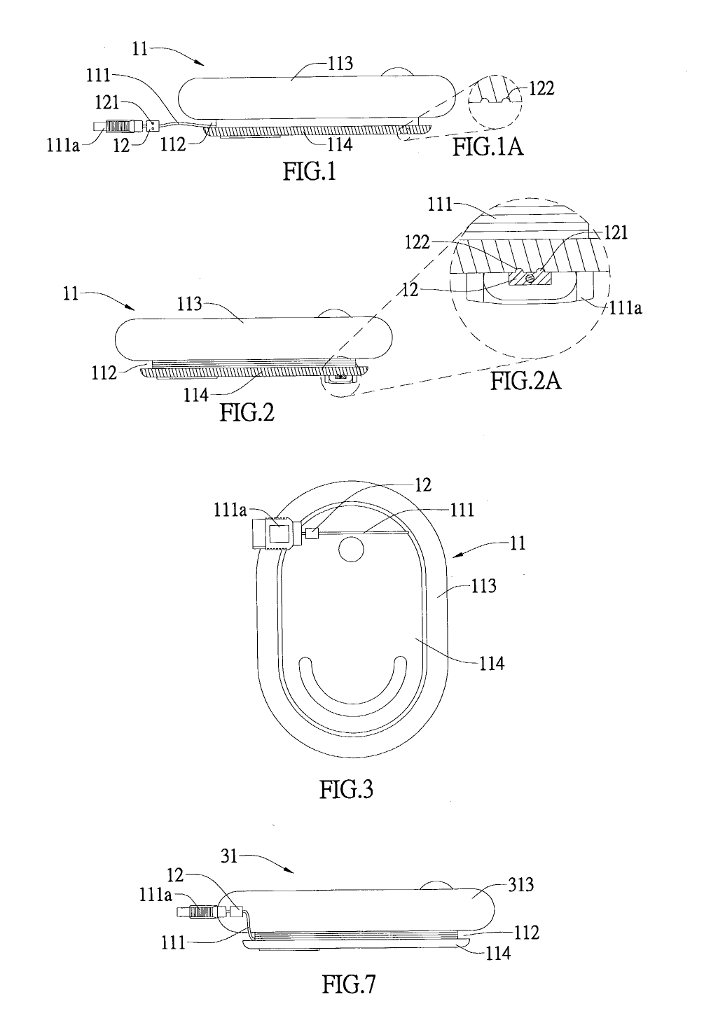

Please refer to FIGS. 1, 1A, 2, and 2A in which a mouse cord stowing mechanism according to a first embodiment of the present invention is shown. The mouse cord stowing mechanism of the present invention mainly includes a groove 112 provided on a mouse 11 having a mouse cord 111. The mouse 11 includes an upper case 113 and a lower case 114, and the groove 112 is provided on the mouse 11 between the upper and the lower case 113, 114. The mouse cord 111 is extended from an interior of the mouse 11 to pass through the groove 112. A connector 111a is connected to a free end of the mouse cord 111.

The mouse cord stowing mechanism further includes a locating member 12 provided on the mouse cord 111 closely behind the connector 111a. The locating member 12 is provided at a predetermined position with an engaging portion 121, which is a dot in the illustrated drawings. A receiving portion 122 forming part of the mouse cord stowing mechanism is correspondingly provided at an underside of the lower case 114 of the mouse 11 for engaging with the engaging portion 121. In the illustrated drawings, the receiving portion 122 is a recess matching with the dot forming the engaging portion 121.

Please also refer to FIG. 3. When the mouse 11 is not in use, the mouse cord 111 maybe wound around and thereby stowed in the groove 112 to occupy only a very small space. When the mouse cord 111 is orderly and smoothly wound around the groove 112, deformation of the mouse cord 111 due to any external pressure possibly applied thereto may be avoided. The mouse cord 111 may therefore have an extended usable life.

When the mouse cord 111 has been wound around and stowed in the groove 112, the mouse cord 111 and the connector 111a provided at the free end thereof are prevented from loosening from the groove 112 by engaging the engaging portion 121 on the locating member 12 provided closely behind the connector 111a with the receiving portion 122 provided at the underside of the lower case 114 of the mouse 11, so that the connector 111a is attached to the lower case 114 of the mouse 11 via the locating member 12.

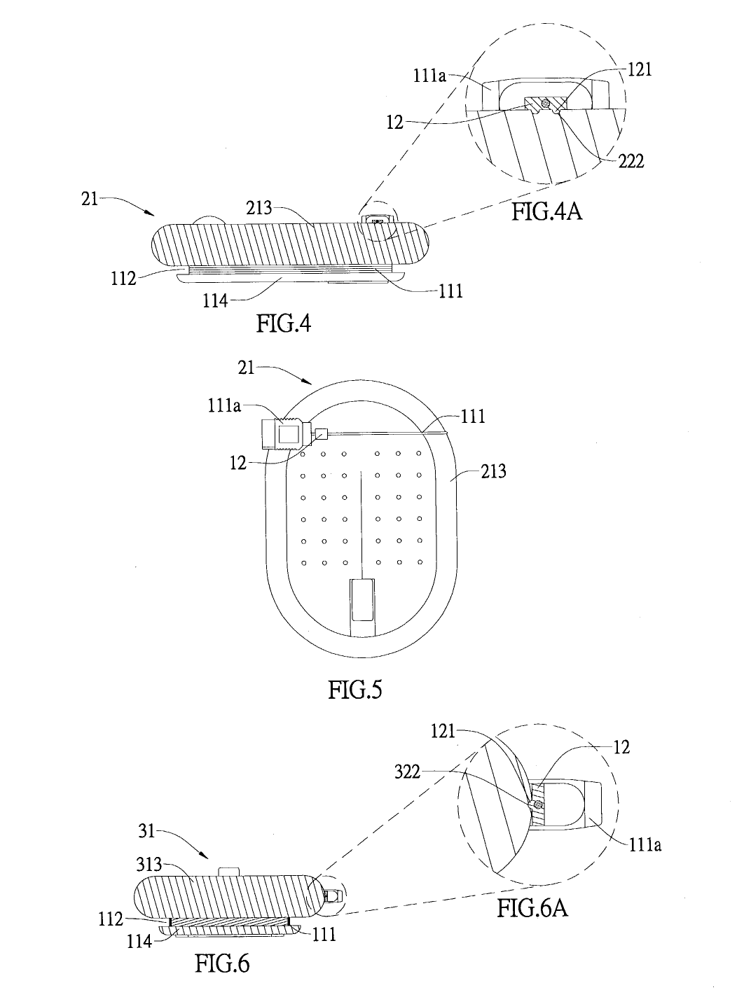

Please refer to FIGS. 4, 4A, and 5 in which a mouse cord stowing mechanism according to a second embodiment of the present invention is shown. The second embodiment is generally structurally and functionally similar to the first embodiment, except that it includes a receiving portion 222 provided on a top of an upper case 213 of a mouse 21 for engaging with the locating member 12.

Please refer to FIGS. 6, 6A, and 7 in which a mouse cord stowing mechanism according to a third embodiment of the present invention is shown. The third embodiment is generally structurally and functionally similar to the first embodiment, except that it includes a receiving portion 322 provided on one lateral side of an upper case 313 of a mouse 31 for engaging with the locating member 12.

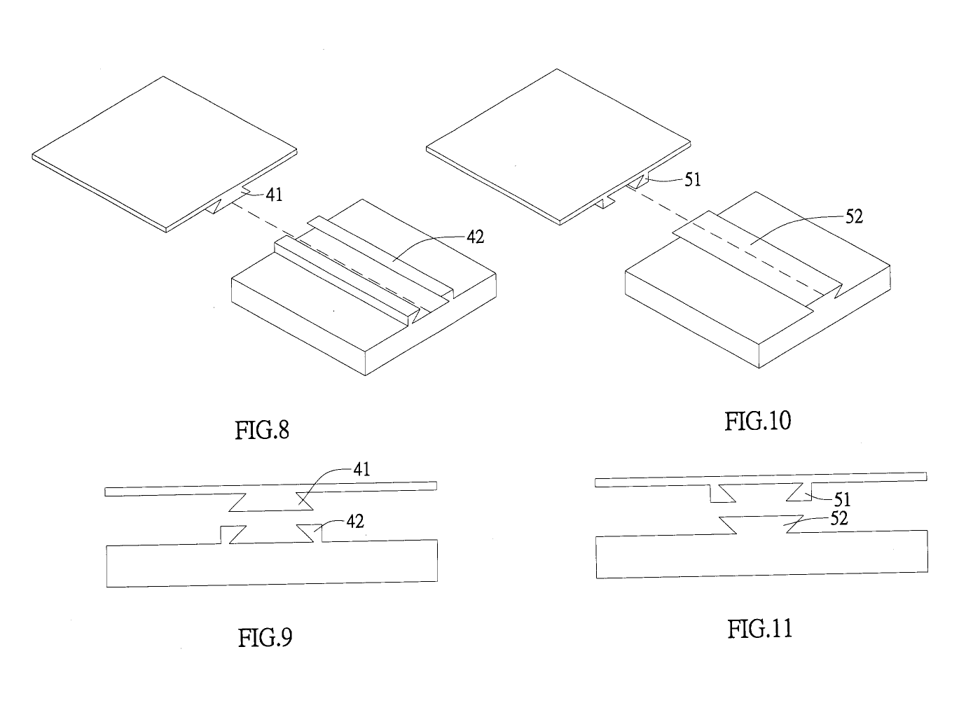

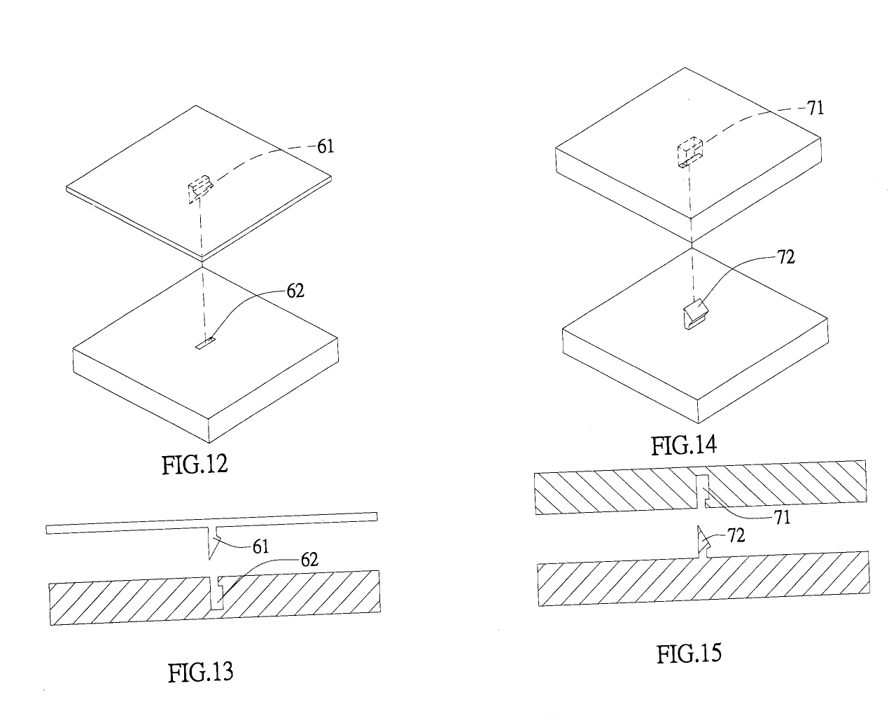

In the above-illustrated three embodiments, the engaging portion 121 and the receiving portions 122, 222, 322 maybe differently designed. For example, the engaging portion 121 may be a dovetail tenon 41 and the receiving portion 122, 222, 322 may be a corresponding dovetail slot 42 for the dovetail tenon 41 to slide therein, as shown in FIGS. 8 and 9. Alternatively, the engaging portion 121 may be a dovetail slot 51 and the receiving portion 122, 222, 322 may be a corresponding dovetail tenon 52 slidably received in the dovetail slot 51, as shown in FIGS. 10 and 11. In the above-mentioned two examples, the locating member 12 is allowed to quickly slide into and out of the receiving portion 122, 222, 322 for the connector 111a to attach to and detach from the mouse 11, respectively. In a further example, the engaging portion 121 may be an arrowheaded hook 61, and the receiving portion 122, 222, 322 may be a corresponding retaining slot 62. In a still further example, the engaging portion 121 may be an retaining slot 71, and the receiving portion 122, 222, 322 may be a corresponding arrowheaded hook 72. In the two latter examples, the locating member 12 is allowed to quickly snap onto and disengage from the receiving portion 122, 222, 322 for the connector 111a to attach to and detach from the mouse 11, respectively.

The present invention has been described with some preferred embodiments thereof and it is understood that many changes and modifications in the described embodiments can be carried out without departing from the scope and the spirit of the invention as defined by the appended claims.

What is claimed is:

1. A mouse cord stowing mechanism, comprising a groove provided on a mouse having a mouse cord, a locating member provided on said mouse cord closely behind a connector connected to a free end of said mouse cord, an engaging portion provided on said locating member, and a receiving portion provided at a predetermined position on said mouse corresponding to said engaging portion; said groove being designed for said mouse cord to wind therearound when said mouse is not in use, said locating member being adapted to attach to said mouse through engagement of said engaging portion with said receiving portion and thereby fixing said free end of said mouse cord wound around said groove and accordingly said connector connected thereto to said mouse without the risk of easily loosening therefrom.

2. The mouse cord stowing mechanism as claimed in claim 1, wherein said engaging portion on said locating member is a dot, and said receiving portion on said mouse is a recess corresponding to said dot.

3. The mouse cord stowing mechanism as claimed in claim 1, wherein said engaging portion on said locating member is a dovetail tenon, and said receiving portion on said mouse is a dovetail slot corresponding to said dovetail tenon for said dovetail tenon to slide therein.

4. The mouse cord stowing mechanism as claimed in claim 1, wherein said engaging portion on said locating member is a dovetail slot, and said receiving portion on said mouse is a dovetail tenon corresponding to and slidable in said dovetail slot.

5. The mouse cord stowing mechanism as claimed in claim 1, wherein said engaging portion on said locating member is an arrowheaded hook, and said receiving portion on said mouse is a retaining slot corresponding to said arrowheaded hook for the latter to engage therewith.

6. The mouse cord stowing mechanism as claimed in claim 1, wherein said engaging portion on said locating member is a retaining slot, and said receiving portion on said mouse is an arrowheaded hook corresponding to said retaining slot for engaging therewith.
